(19) United States
(12) Patent Application Publication
(10) Pub. No.: US 2019/0325070 A1
(43) Pub. Date: Oct. 24, 2019

(54) SYSTEMS AND METHODS TO FACILITATE TEXT CONTENT SEARCH

(71) Applicant: NEGENTROPICS Mesterseges Intelligencia Kutato es Fejileszto Kft., Budapest (HU)

(72) Inventor: Béla Lóránt KOVÁCS, Debrecen (HU)

(73) Assignee: NEGENTROPICS Mesterseges Intelligencia Kutato es Fejleszto Kft.

(21) Appl. No.: 15/959,739

(22) Filed: Apr. 23, 2018

(51) Int. Cl. G06F 17/30; G06F 3/0486

(52) U.S. Cl. CPC G06F 17/30867; G06F 17/30554; G06F 3/0486; G06F 17/30309; G06F 17/30398

(57) ABSTRACT

A user interface system for performing searches in text-containing documents including a graphical user interface. The system may include a query window management system operable to display a query window for receiving a query text input by a user; a search result presentation system operable to display a search result window for displaying a result list of relevant documents returned by a search; a preview window management system operable to display a preview window for displaying at least part of the content of a relevant document listed in the search result window; and an activation tool operable to start a search at a search engine based on the query text, wherein the query window management system is adapted to receive a text of any length in the query window and to forward the text received in the query window to the search engine.

### TECHNICAL FIELD

The present disclosure generally relates to systems and methods to facilitate text content search. In particular, the present disclosure relates to user interface systems facilitating searches in a body of text-containing documents and methods of operating a graphical user search interface of user computing devices.

### BACKGROUND

A software module called a “search engine” is commonly used to search for particular data in a body of data on a computing device. Although it is possible to programmatically access and use a search engine, it is more convenient for users to access and use a search engine through a graphical user interface, called a search user interface.

An example of a general search user interface is a Web search user interface, such as the Web search user interfaces of the browser applications including Microsoft Internet Explorer™, Mozilla Firefox™, Opera™, etc. Typically, a Web search user interface comprises a text box in which searchable terms can be entered, a button to launch a search, and an area to display the results of a search. A Web search user interface has the advantage of enabling searches of a plurality of different files. However, as most users are comfortable with entering searchable terms into a text box, a Web search user interface is generally adequate for simple searches based on the words typed into the search text box. If a simple search fails to return useful data or returns too much data, a more complex search will be required.

Most of the text-based search user interfaces have been designed to receive a limited number of characters in the search text box. Widely used search engines, such as Google™, Bing™, Elastic Search™, etc. have strict limitations regarding the scale of the usable search query text. These limitations may have a negative effect on success in finding relevant information in large textual databases. For example, the Google™ search engine currently accepts a query text of up to 2046 characters. The limited number of characters that can be entered into a search query text box is optimized for keyword-based searches for any kind of content. However, there is an increasingly growing demand for conducting searches on semantic basis, wherein documents having content similar to the query text are to be found among a large variety of text-containing electronic documents, typically including online news, electronic copies of technical or scientific papers, books, official documents, etc. In this kind of search the chance of success of finding the most relevant documents best matching to the query text climbs significantly higher as the length of the query text increases since the longer the query text is, the more useful semantic information can be gained from it. This demand thus makes it necessary to use a search text box with the capability of receiving significantly more characters than in the known search user interfaces, to include the full text of a complete document. At the same time, however, users might be confronted with the problem of how to enter rather long query texts or re-enter long preceding queries and how to modify the current or any previous query term in order to obtain a new, possibly better search result.

### SUMMARY

Disclosed embodiments include systems and processes for providing a user interface performing semantic search in a body of text-containing documents.

One aspect of the present disclosure is directed to a user interface system for performing search in a body of text-containing documents, the user interface system being operable to manage a graphical user interface, GUI, of a user device through a communication network. The system may include a query window management system; a search result presentation system operable to display a search result window for displaying a result list of relevant documents returned by a search; a preview window management system operable to display a preview window for displaying at least part of the content of a relevant document listed in the search result window; and an activation tool operable to start a search at a search engine based on the query text, wherein the query window management system is adapted to receive a text of any length in the query window and to forward the text received in the query window to the search engine. The query window management system may be operable to display a query window for receiving a query text input by a user from, for example, at least one of a text shown in the query window, a text shown in the preview window, a text shown in a document, a text document moved by the user into the query window through a drag-and-drop operation, or a text document uploaded by the user from a local or remote file system.

Another aspect of the present disclosure is directed to a computer-implemented method of interfacing with a search engine. The method may include: displaying a graphical user search interface on a screen of a user device; receiving in the query window, a text input by a user from at least one of a text shown in the query window, a text shown in the preview window, a text shown in a document, a text document moved by the user into the query window through a drag-and-drop operation, or a text document uploaded by the user from a local or remote file system, and forwarding the text in the query window to the search engine. The graphical user search interface may include a query window for receiving a query text, wherein the query window is adapted to receive text of any length, a search result window for displaying a result list of relevant documents returned by a search, a preview window for displaying at least a portion of a relevant document listed in the search result window, and an activation tool operable to start the search at a search engine based on the query text.

Another aspect of the present disclosure is directed to a non-transitory computer-readable storage medium storing computer program instructions. The program instructions may be configured to instruct a computer processor to: display a graphical user search interface; receive, in the query window, a text input by a user from at least one of a text shown in the query window, a text shown in the preview window, a text shown in a document, a text document moved by the user into the query window through a drag-and-drop operation, or a text document uploaded by the user from a local or remote file system, and forward the text received in the query window to the search engine. The graphical user search interface may include: a query window for receiving a query text, wherein the query window is adapted to receive a text of any length, a search result window for displaying a result list of relevant documents returned by a search, a preview window for displaying at least part of a relevant document listed in the search result window, and an activation tool operable to start the search at a search engine based on the query text.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A is block diagram of an exemplary environment in which a search server system performs a search in accordance with disclosed embodiments.

FIG. 1B is block diagram of another exemplary environment in which a search server system performs a search in accordance with disclosed embodiments.

FIG. 2 is an illustration of an exemplary graphical user interface presented by the user interface system in accordance with disclosed embodiments.

FIG. 3 is a block diagram of an exemplary embodiment of the user interface system in accordance with disclosed embodiments.

FIG. 4 is a block diagram of an exemplary embodiment of the user interface system in accordance with disclosed embodiments.

FIG. 5 is a schematic illustration of the interactions between the components of the user interface system and the graphical user interface components displayed on a user device in accordance with disclosed embodiments.

FIG. 6 is an exemplary design of the query history window in accordance with disclosed embodiments.

FIG. 7 is a flow diagram of a search method in accordance with disclosed embodiments.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

A graphical user interface to receive search text from a user and communicate the search text with a search engine provides a flexible and convenient solution for using long query texts in a search user interface, in particular, in a search user interface used with semantic search engines.

Finding necessary information may require using meaningful sentences or complete paragraphs or documents in a search engine query. In some cases, a user may be required to find similar contents or documents relating to the meaning of the query text. However, current search engines have limitations on the size of search query text. Thus, it is often difficult or impossible to perform such kind of searches effectively.

A semantic search engine as describe in U.S. application Ser. No. 15/729,296, filed on Oct. 10, 2017, which is incorporated herein by reference, in contrast with the commonly used other textual search systems, has no limitations regarding the length of search query text. Disclosed embodiments of a user interface may enable a user to input a search query of any length into the semantic search engine.

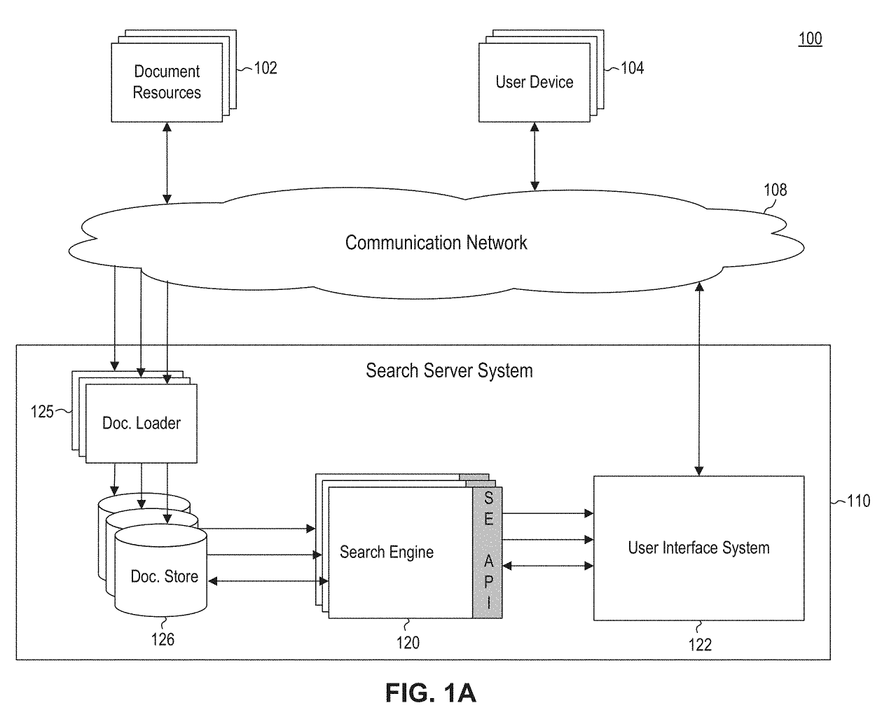

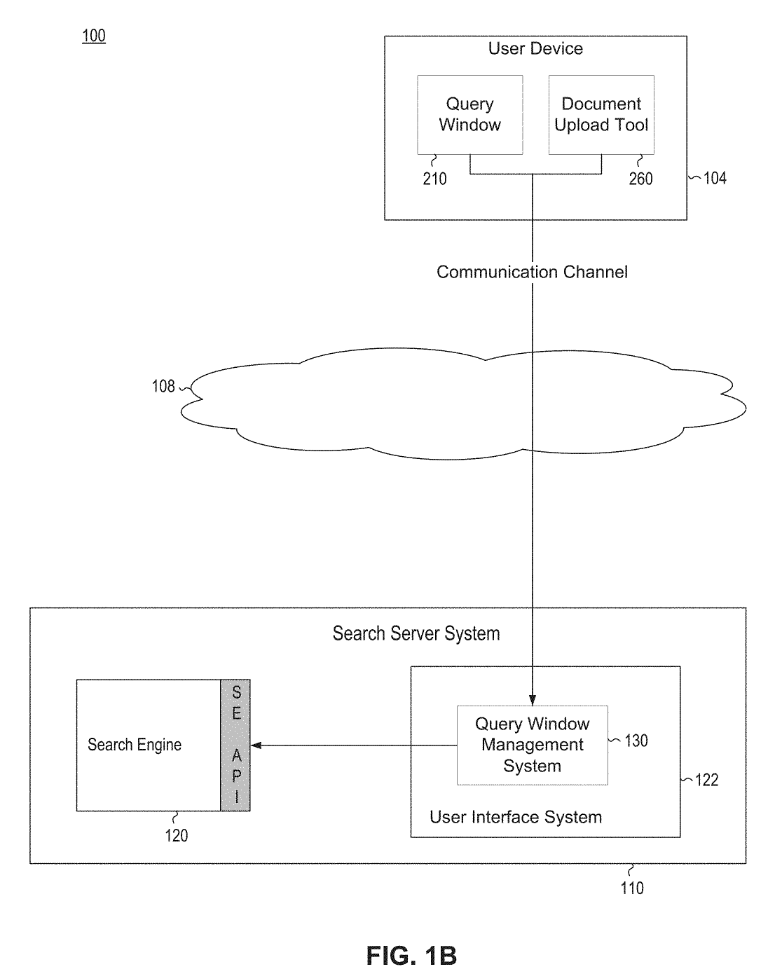

Managing large scale textual content within the query window of a script-based graphical user interface running in most commonly used web-browsers requires a solution to the problem of providing real-time user experience while using large scale search queries. In some embodiments, the system may enhance the user experience by forwarding large textual data from the query window of the GUI running on different kinds of widely used end-user devices through local or global networks (LAN/WAN) to the server side query management system serving the search engines (FIG. 1B). Disclosed embodiments use a novel encoding technique and specific buffer management.

Disclosed embodiments provide simple and easily understandable management of large scale search query text, without any limitation regarding the size or length of input search query text. Disclosed embodiments provide a flexible method of modifying the search query using the text of the previous search results and of initiating search activities with large scale search query text, including an effective communication method between the user interface and the server side semantic search engine.

An embodiment of a search dialogue user interface facilitates communications with a search engine and archives such communications. The search dialogue user interface may allow users to effectively manage their respective search histories. Each respective search history may be maintained in the form of a query text and/or one or more associated features of the particular query. Query messages entered by the user may be displayed within the search dialogue interface, and submitted to a search engine. A list of the search results returned by the search engine may be displayed in a specific window of the search dialogue user interface.

In some embodiments, via a query history tool, a user may manage and access previous searches based on their query texts and their associated one or more query features, and thus more efficiently utilize the historical query information. For example, the search dialogue user interface enables users to access a previously executed search query text and to modify and/or refine the query to proceed with a new search query.

FIG. 1A is a block diagram of an example environment 100 in which a search server system 110 provides search services. A communication network 108, such as a local area network (LAN), wide area network (WAN), the Internet, or a combination thereof, connects document sources 102, (e.g., publisher web sites, document stores), user devices 104, and the search server system 110.

The search server system 110 may include at least one search engine 120 and a user interface system 122 according to the present disclosure. In some embodiments, the search engine 120 is a semantic search engine. When the search engine 120 is configured to perform semantic search, the search server system 110 may further include a document store 116 of text documents generated from the source documents of various types including, for example, text, hypertext, image, video, audio or any combination thereof. The source documents may be maintained by one or more content providers, which are entities that control, manage and/or own a document source. A source document 102 may be any data provided by a publisher over the communication network and that is associated with a resource address. Source documents may include, for example, HTML pages, word processing documents, portable document format (PDF) documents, images, video, multimedia documents, etc. The source documents may include content, such as words, phrases, pictures, video and so on, and may include embedded information (such as meta information and hyperlinks) and/or embedded instructions (such as JavaScript scripts).

A user device 104 may be an electronic device controlled by a user and capable of requesting and receiving search information and source documents 102 over the network from the search server system 110. Example user devices 104 include personal computers, mobile communication devices, and other devices that can send and receive data over the communication network 108. A user device 104 typically includes a user application, such as a web browser, to facilitate the sending and receiving of data over the network 108. The web browser may enable a user to display and interact with text, images, videos, music and other information typically located on a web page at a website on the World Wide Web or a local area network.

To facilitate searching source documents, the search engine 120 may identify one or more source documents by crawling publishers' document sources and indexing the accessed source documents. When the source documents are processed into text documents with indexes for semantic search, the search engine 120 performs the search among these text documents using the indexes associated therewith.

FIG. 1B is a block diagram of another arrangement of environment 100 in which a search server system 110 provides search services. A communication network 108, such as a local area network (LAN), wide area network (WAN), the Internet, or a combination thereof, connects a user device 104 and the search server system 110.

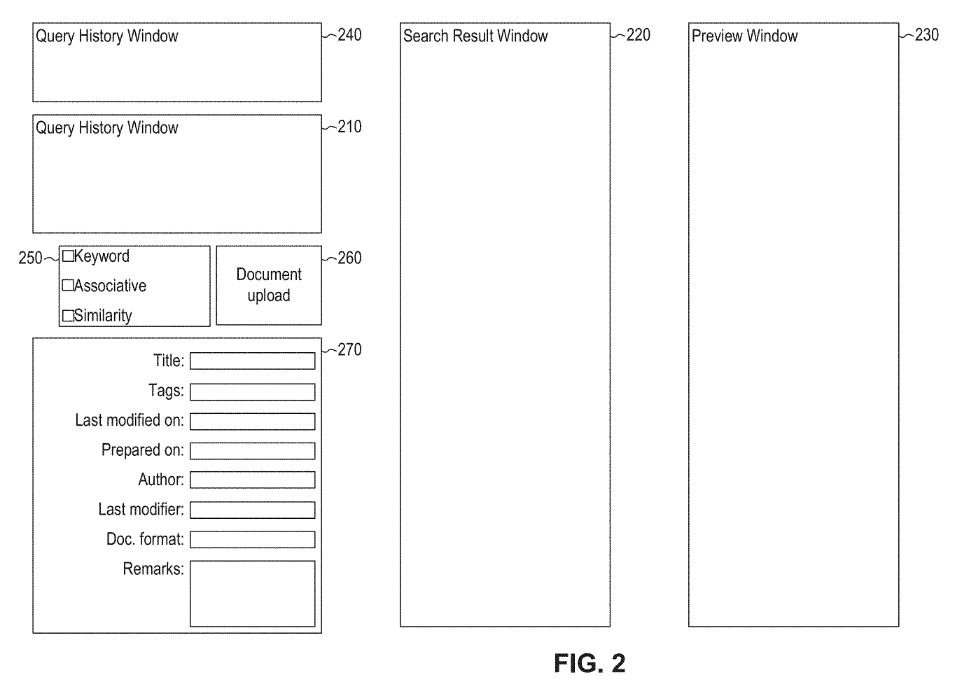

The user device 104 may display a graphical user interface including at least a query window 210 and a document upload tool 260, which will be further described below with reference to FIG. 2. The search server system 110 may include at least one search engine 120 and a user interface system 122 according to the present disclosure. In some embodiments, the search engine 120 is a semantic search engine, as described with reference to FIG. 1A.

A user device 104 may be an electronic device controlled by a user and capable of requesting and receiving search information over the network 108 from the search server system 110, via a communication channel. In some embodiments, the communication channel may be optimized to transmit large scale text data.

User device 104 may transmit search information, via network 108, to a query window management system 130, which is described in further detail below. The query window management system 130 may be operable to allow a user to edit the text within the query window, which may be implemented in a text pane of the graphical user interface displayed on a screen of a user device 104. The query window management system 130 may also be operable to send the query text to a search engine 120 once the user has completed the query input.

The user interface system 122 of FIGS. 1A and 1B provides instructions to the user devices 104 that cause the user device 104 to generate a graphical user search interface on a display of the user device 104. An example of such an interface 200 is shown in FIG. 2. The graphical user search interface displayed by a user device 104 may include at least a query window 210, a search result window 220, and a preview window 230.

The query window 210 may be an editable text window configured to receive text input from the user by typing, copy-paste operation, drag-and-drop operation, or file upload. In some embodiments, the query window 210 may be capable of receiving any number of characters, meaning that the length of the query text is not limited. In this embodiment, a number of words or phrases may be entered into the query window 210, or a whole text document may be copied and/or uploaded into the query window 210, without size limitation. An unrestricted query window may be highly beneficial when executing a semantic search.

The search result window 220 may be configured to present search result data produced by the search engine upon completing a search. The search result data may include data identifying at least one source document that satisfies a particular search query and may further include a resource locator for the resulted documents to allow the user to open or download the source documents by means of the user device 104. In some embodiments, the search result data includes a relevance indicator for each resulted document. For example, the relevance indicator may be a decimal number representing the relevance of the respective document with regard to the content of the query text.

The search result data may be presented in text form with selectable or actionable text elements, such as hypertext links, to allow the user to select a document to open or download. However, other tools may be used for the selection of a document identified in the search result window.

The preview window 230 may be configured to display at least a part of a relevant source document selected by the user in the search result window 220. In some embodiments, as a default selection, the most relevant source document (i.e., the document with the highest rank value) may be presented in the preview window 230. The preview window 230 may be further configured to highlight the relevant parts of a selected document thereby providing support to the user to quickly find the content of interest within the document. Moreover, the preview window 230 may also be configured to allow the user to anchor any relevant document on the screen of the user device for future reference.

In some embodiments, the graphical user search interface displayed by the user device 104 may include a number of additional windows, fields and tools to provide further functions for making the search more efficient or more convenient for the user. Such additional elements may include, for example, a query history window 240, a search type selection tool 250, a document upload tool 260 and a metadata filter tool 270, which are also illustrated in FIG. 2. The graphical user search interface may also include a search engine selection tool (not shown) for selecting a search engine from a predefined set of search engines.

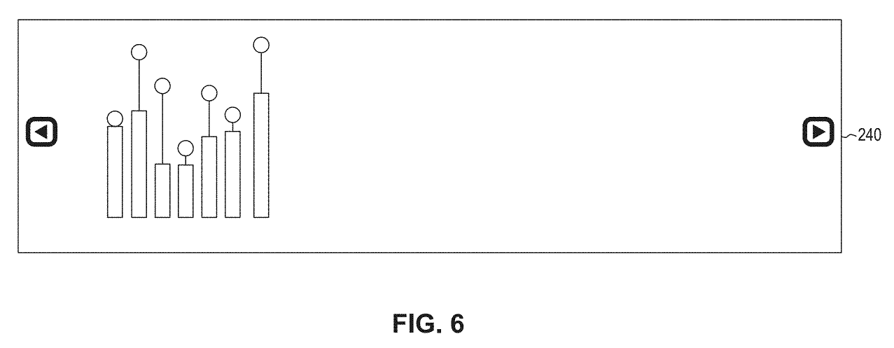

The query history window 240 may be configured to present historical information relating to the previous search runs, including statistics, comparative data with respect to preceding queries, query texts of the previous searches, and so on. An exemplary configuration and design of the query history window will be described later with reference to FIG. 6.

The search type selection tool 250 may be configured to allow the user to select a specific type of search. For example, the type of search may be set to “Keyword,” “Associative,” or “Similarity” by clicking on the check-box of the desired type. The “Keyword” search may be used to run a conventional search using one or more keywords, wherein the resulting documents contain at least one the one or more keywords. The “Associative” and “Similarity” searches may be used to run different kinds of semantic searches typically using longer coherent texts as a basis of the search. In case of an “Associative” search, the resulted documents do not necessarily contain the specified keywords, but their content may be related to the meaning of the one or more keywords. In a “Similarity” search the content of the resulted documents may be similar to the meaning of a longer query text. Those skilled in the art will understand that the search type selection tool 250 may be implemented in many other ways, for example as a menu or other selection tools allowing the user to select a search type from a predefined list of search types.

The document upload tool 260 may be used to move a text document from a local or remote directory of files. In some embodiments, the document upload tool 260 may be implemented using a button or an icon. When the user clicks the button or icon, a graphical file manager may be displayed on the screen of the user device for selecting a file. Once a desired text document has been selected in the file manager, the selected document may be loaded as a whole into the query window 210.

The metadata filter tool 270 may be configured to specify various metadata associated with the source documents. These metadata may include, for example, “Title,” “Tags,” “Last modified on,” “Prepared on,” “Author,” “Last modifier,” “Document format” and “Remarks” as illustrated in FIG. 2. Other metadata may also be included. The available set of metadata may be defined depending on the particular search engines. The metadata fields may be arranged within a window, as shown in FIG. 2, or they may be arranged in a field of the graphical user search interface.

Referring again to FIG. 1A, the operation of the search server system 110 will now be described.

The user devices 104 submit search query messages to the search server system 110. A query message includes text and, in some embodiments, further search information that is descriptive of one or more search criteria. The search engine 120 processes the query messages after an indication that a user has completed a query input. The indication may be, for example, a pause in typing that exceeds a threshold time, or a failure to begin a new query message after the expiration of a time period after sending a previous query message. In some embodiments, instead of starting automatically, the search may be started manually, for example by clicking on a specific button or icon of the graphical user interface displayed by the user device.

In response to a query message, the search engine 120 may identify the source documents that are relevant to the search criteria specified by the query message. A search result may include data generated by the search engine 120 that identifies at least one source document that satisfies a particular search query, and further includes a resource locator for the resulted documents. An example search result may include a document title, a snippet of text extracted from the document, the URL of the web page or other local or remote access path to the source document. The search results may be ranked based on scores or other features relating to the relevant source documents identified by the search results.

The user interface system 122 may receive query messages from the user devices 104 and forwards them to the search engine 120. Once the search engine 120 completes a search by accessing the one or more document sources, or optionally a text document store, the search engine 120 may output the search results to the user interface system 122, which, in turn, may process and forward the search results to the user device 104 via the communication network 108.

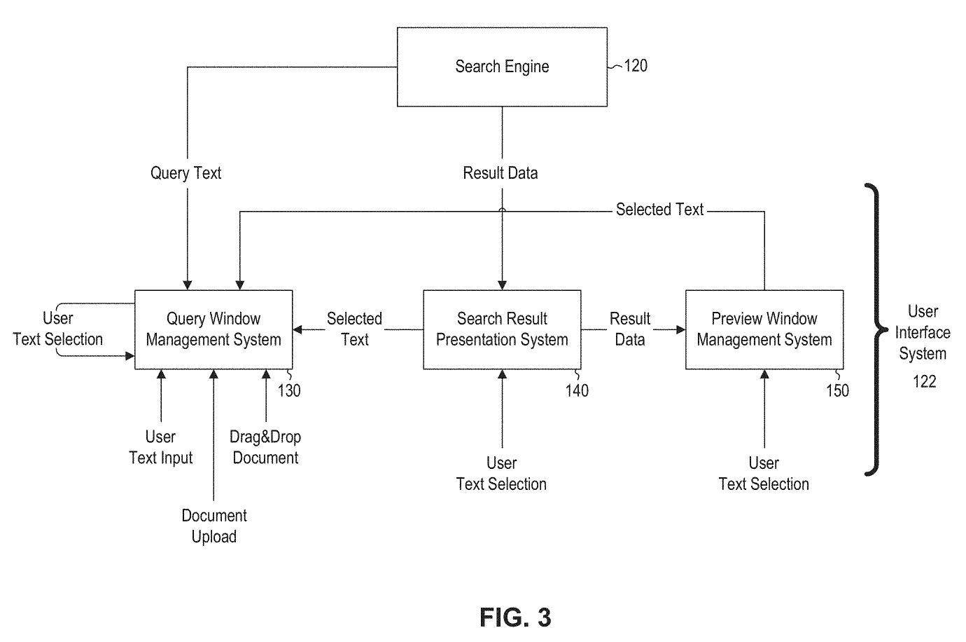

The user interface system will now be described in detail with reference to FIG. 3, which illustrates a schematic block diagram of one embodiment of the user interface system according to the present disclosure, and also indicates user interactions and system messages sent between entities of the user interface system 122.

The user interface system 122 may include a query window management system 130, a search result management system 140, and a preview window management system 150.

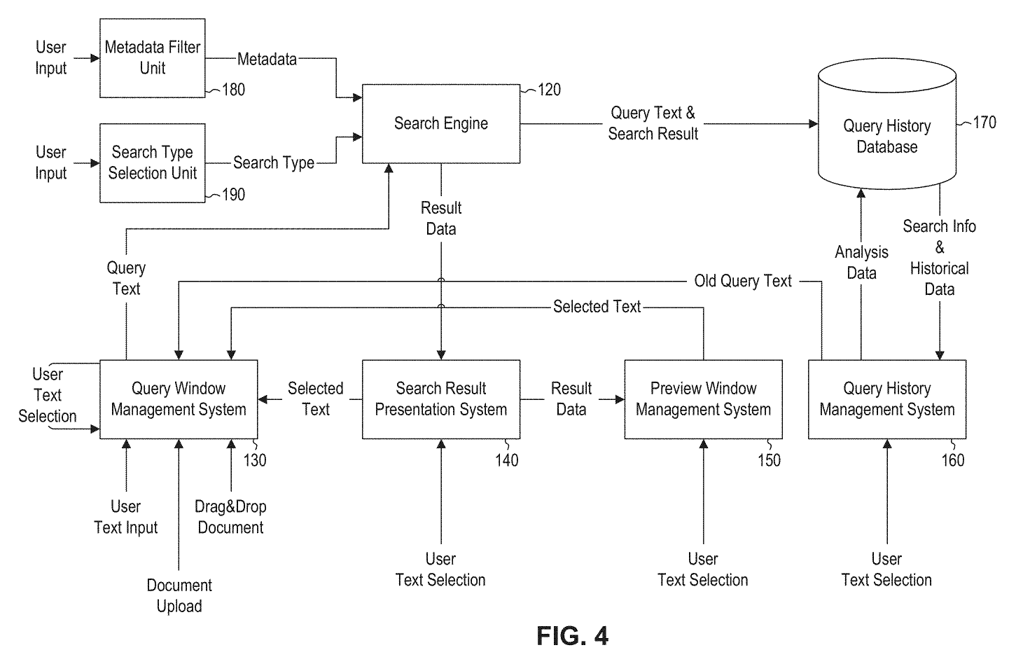

In some embodiments, the user interface system 122 may include a query history management system 160 and a query history database 170. Other embodiments of the user interface system 122 may further include a search type selection unit 190 and a metadata filter unit 180 also shown in FIG. 4.

### Query Window Management System

The query window management system 130 may be operable to allow a user to edit the text within the query window, which may be implemented in a text pane of the graphical user interface displayed on a screen of a user device 104. Editing the text within the query window may include one of the following operations: typing a text into the window, e.g., adding a new text to the current text or replacing the current text with a new text; copying a text into the window in addition to the current text or to replace the current text with it; moving a text document into the query window by drag-and-drop action; or uploading a text document from a local or remote location. When copying a text, the source text may be taken from an open window or text pane displayed on the graphical user interface of the user device 104, including the query window itself.

The drag-and-drop operation may include moving an icon of a text document from any other computer application (e.g., a desktop of a window-based operation system, a graphical file manager tool, etc.) into the editable field of the query window, upon which the text content of the document associated with the icon may be displayed within the query window either in addition to or instead of the text originally shown therein, depending on the editing mode of the query window.

In some embodiments, when a user uploads a file, the text content of the uploaded document may be displayed within the query window in addition to or instead of the current text shown therein, depending on the editing mode of query window.

In some embodiments, when any parts of the query term within the search window are selected, the selected text may be immediately used as a new query text for narrowing or refining the scope of search. In this embodiment, the user does not have to delete the content of the query window in order to run a new search. Instead, selecting text may activate an appropriate launch tool of the graphical user interface of the user device to start a new search with the recently selected text.

The query window management system 130 may also be operable to send the query text to a search engine 120 once the user has completed the query input. As mentioned above, the completion of the query input may be indicated by, e.g., a pause in typing that exceeds a threshold time, or the activation of a user-indicator, such as the activation of a specific button or a pop-up menu element presented on the graphical user interface of the user device.

Search Result Presentation System

The search result presentation system 140 may be operable to receive search result messages from the search engine 120 and to present the search result data in the search result window of the graphical user interface displayed on the screen of the user device 104. As mentioned above, the search result data may identify at least one source document that satisfies a particular search query, and may further include a resource locator for the resulted documents. The search result presentation system 140 may be further operable to allow the user to select a document of the ranked list of document identification data to open it in the preview window. The search result presentation system 140 may also be configured to allow the user to open a selected document in a separate window of a specific document viewer application, or to download it from a local or remote document resource by activating the resource locator, such as an URL, associated with the selected document.

The search result presentation system 140 may further be configured to allow the user to delete any of the items from the result list, when one or more items relate to less interesting documents. Deletion of one or more items from the result list may be used to enhance the quality of future searches. In some embodiments, the identifiers of the deleted documents may be stored in the query history database in relation with the respective query text.

The search result presentation system 140 may also be configured to allow the user to evaluate relevance of the resulted documents, thereby further improving the quality of future searches. To this end, the search result presentation system 140 may be adapted to receive user-specified rank values through the search result window and to forward them to the search engine. In some embodiments, these rank values may be stored in the query history database in relation with the respective documents and the query text.

Once a search result has been displayed in the search result window, the search result presentation system 140 may allow the user to copy any portion of the displayed information into the query window without size limitation. For the selection of a larger portion of the result list than presented in the search result window, the window may be scrolled while the desired text part is being selected. The selected part of the result list may be added to the current text of the query window at any position thereof, or the current text contained in the query window may be replaced, in whole or in part, with the selected part of the result list. Preview Management System

The user interface system 122 may include a preview management system 150 operable to present, in a preview window, at least a portion of a source document, the identifier of which may be selected by the user in the search result window. As a default selection, a portion of the most relevant source document may be presented in the preview window. In some embodiments, the portion of the source document containing the query text is shown in the preview window. When a semantic search is carried out, the portion of the source document containing a text semantically similar to the query text may be shown in the preview window.

When a portion of a relevant document is presented in the preview window, any part of the presented portion may be copied or loaded into the query window without size limitation. For the selection of a larger portion of a document than the portion presented in the preview window, the preview window may be scrolled while the desired section is selected. The selected portion of the document may be added to the current text of the query window at any position thereof, or the current text, in whole or in part, may be replaced with the selected portion of the document.

### Additional Components of the User Interface System

FIG. 4 illustrates a schematic block diagram of an embodiment of the user interface system according to the present disclosure. The user interface system 122 shown in FIG. 4 may include a query history sub-system including a query history management system 160 and a query history database 170. In some embodiments, the user interface system 122 may include a metadata filter unit 180 and a search type selection unit 190, either separately or in combination. In an embodiment, user interface system 122 may include a search engine selection unit when multiple search engines are in use within the system. Separate semantic search engines may be used for different document databases containing, e.g., different type of documents (legal, technical, medical, etc.) or documents in different languages. The user interface system may connect to different search engines of various software developers (e.g., Elastic Search™, Google™, Microsoft™, etc.).

The query history management system 160 may be operable to control the operation of the query history window of the graphical user search interface displayed by the user device 104. In particular, the query history management system 160 may be configured to receive user selection input with respect to a particular old query, to send a request for retrieving historical search data from the query database 170, to receive historical search data from the query history database 170 and to display the retrieved historical search data in the query history window of the graphical user search interface of the user device. The query history data may include partly or wholly presented interactive information elements, each of which is associated with a particular previously executed query.

The historical search data may include, for example, old query texts, search results of old queries, statistics over old queries and so on.

The query history database 170 may receive and store query texts and the associated search result data and also forward them to the query history management system 160 for statistical processing, comparative processing, etc. After receiving search result data for a new query and processing it, the result of the analysis may be returned to and stored in the query history database 170. At the same time, updated presentation information may be generated by query history management system 160, which, in turn, updates the view of the information element(s) displayed in the query history window 240.

Once a user has selected a particular information element within the query history window 240 and the query history management system 160 has detected the selection, the query history data belonging to the selected information element may be retrieved from the query history database 170 by the query history management system 160. The query history management system may display the retrieved query history data in the query history window 240 in a predefined form to provide the user with appropriate historical information, e.g., statistics, metrics, query text, etc., with regard to the old query at issue. The predefined form of presentation of historical data of old queries may include, for example, displaying the retrieved historical data adjacent to the view of the particular information element or at any other location within the query history window.

The query window management system 130 may also be configured to receive a text selected by a user from the text displayed in the query history window 240 upon selection of an interactive element in the query history window 240 by the user. This option further facilitates the input of a query text by allowing the user to easily access previously executed search queries and to re-use them in new search runs.

The metadata filter unit 180 may be operable to receive specific metadata from the user for limiting the scope of the search to a portion of the source documents thereby making the search more focused or faster. The metadata may be entered through a metadata filter tool displayed on the graphical user search interface of the user device 104. The metadata filter unit 180 may then forward the available metadata to the search engine 120 for use at the search.

The search type selection unit 190 may be operable to receive search type selections from the user through a search type selection tool displayed on the graphical user search interface of the user device 104. The search type selection unit 190 may then forward the selected type of search to the search engine 120 which then performs the selected type of search.

The search engine selection unit may be operable to receive selection information regarding the user's preferred search engine. If the search engine selected by the user differs from a default search engine, the query text, the metadata and the search type selection data may be forwarded to the selected search engine. The desired search engine may be selected from a predefined set of search engines through a search engine selection tool displayed on the graphical user search interface of the user device 104.

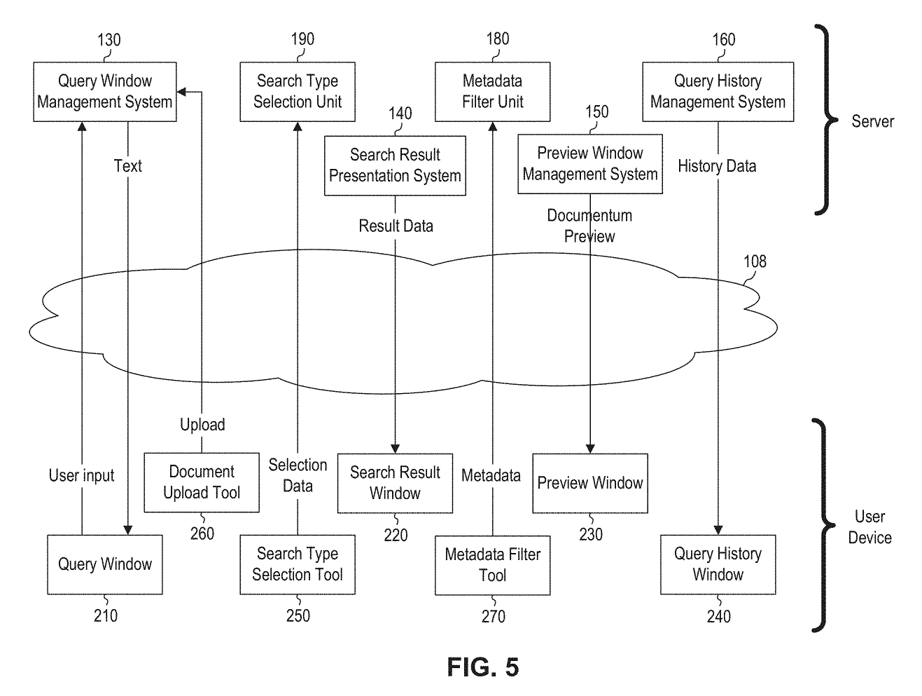

FIG. 5 schematically illustrates the interactions between the components of the user interface system residing in a server and the graphical user interface components displayed on a user device.

As shown in FIG. 5, the interactions between the components of the user interface system and the graphical user interface components displayed on a user device are performed via a communication network 108, such as the Internet or an intranet, as mentioned above.

The query window management system 130 may receive text data directly or indirectly input by the user into the query window 210 and may receive document uploads from the document upload tool 260, and may manage the displaying and editing operations in the query window 210, such as typing, copying, dropping, uploading, etc., into the window.

The search result presentation system 140 may send search result data to the search result window 220 for presentation to the user. The search result window 220 may also allow the user to select any item of the resulted list of documents and to activate a resource locator of any item of the list, for example, to open or download the selected documents. This latter function renders the search result window 220 an interactive window.

The preview window management system 150 may be configured to display at least a part of a document in the preview window 230. The displayed document may be selected by the user using the list of relevant documents displayed in the search result window 220. The preview window 230 may also allow copying a text portion of the displayed document into the query window 210 by the user. The selected text portion may be automatically added to the current text contained in the query window 210. The automatic text transfer between the preview window 230 and the query window 210 may be carried out, e.g., automatically after a pause in selecting the text that exceeds a threshold time, or upon the activation of a pasting tool within the preview window 230, such as clicking on a respective item of a pop-up menu when the text selection has finished.

The query history management system 160 may display the historical search data in the query history window 240, which may be an interactive window that contains information elements activatable by the user for obtaining more historical details associated with each information element. In response to activation of a particular information element shown in the query history window 240, the query history management system 160 may detect the selection and identify the selected information element. After retrieving the respective query history data from the query history database 170, the query history management system may display these data in the query history window 240.

The user may use the search type selection tool 250 to specify the type of search to be performed. The information relating to the selected type may be received by the search type selection unit 190. Similarly, the user may use the metadata filter tool 270 to specify one or more metadata of the source documents for use in directing the search. The metadata specified by the user input may be received by the metadata filter unit 180.

An example of the design of the query history window 240 is schematically illustrated in FIG. 6. The window may contain a widget that is formed of multiple graphical elements. The widget may include a histogram showing two kinds of symbols for each previous search. One symbol, like the lower columns in FIG. 6, may represent the length of a particular prior query text, whereas the other symbol, like the circles above the columns in FIG. 6, may represent the difference between two consecutive query texts. The difference may be defined in terms of character number or in semantic terms when semantic searches have been performed. The size of the symbols, like the height of the lower columns and the diameter of the upper circles, may be proportional to the numerical value they represent.

A graphical element may be selected by pointing to it, e.g., by using the mouse. Upon selection of a column, the associated query text may be displayed adjacent to the column or at any other location within the query history window 240. Upon activation of the selected column, e.g., by the user clicking on the column, the associated query text may be automatically copied into the query window 210. Similarly, upon selection of a circle, a value of difference may be shown adjacent to the circle or at another location within the query history window 240.

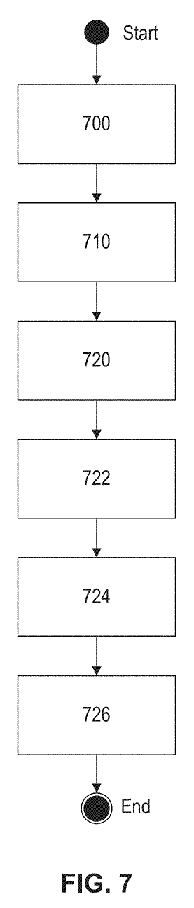

A computer-implemented method of interfacing with one or more search engines included in a search server system, such as the search server system 110 shown in FIGS. 1A and 1B, is shown in FIG. 7. The method may comprise the following steps carried out by a processor device.

In step 700 a graphical user search interface may be displayed on the screen of a user's computing device. The graphical user search interface may include a query window for receiving a query text, a search result window for displaying a result list of relevant documents, a preview window for displaying at least part of the content of a relevant document listed in the search result window, and an activation tool operable to start a search based on a query text. Those skilled in the art will understand that further windows, fields or tools may also be presented by the graphical user search interface.

Before starting a search via a search engine, in step 710, the system may receive search text typed by a user in the query window, selected by a user from a text shown in the query window itself, selected by a user from a text shown in the preview window, selected by a user from a text shown in a previously opened document editor, moved by a user into the query window through a drag-and-drop operation, and/or uploaded by a user from a local or remote file system.

In the above specified step 710 of receiving a text in the query window of the graphical user search interface, the query window may receive a text of any length. For specific search engines, the query text may contain more than 2046 characters, for example, the query text may include a text file of a few kilobytes or more. The upper limit of the length of the query text is defined by the capabilities of the applied search engine.

In one embodiment, a query history window may be displayed in step 720 for presenting historical data of previously executed queries. The historical data may be displayed in the form of interactive graphical information elements in the query history window, where each information element may be associated with a particular prior query. Upon selection of a first type of interactive element by a user in step 722, the method may further comprise displaying a query text associated with the selected information element in step 724.

In some embodiments, upon selection of an interactive element in the query history window by a user, the selected text may either partly or wholly be moved by the user into the query window to form a new query text or to be added to the current text of the query window. Accordingly, the method may further include receiving the text selected by a user from the text displayed in the query history window, once the user has selected an interactive element in the query history window in step 722. The query text associated with the selected information element may be displayed in step 724.

Upon selection of a second type of interactive element in the query history window by a user, the method may further comprise presenting a difference between the query text associated with the selected information element and the query text associated with the preceding information element in step 726.

Although an example user interface system has been described above, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions, encoded on computer storage medium for execution by, or to control the operation of, data processing apparatus. Alternatively or in addition, the program instructions may be encoded on an artificially-generated propagated signal, e.g., a machine-generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

What is claimed is:

1. A user interface system for performing a search in a body of text-containing documents, the user interface system being operable to manage a graphical user interface, GUI, of a user device through a communication network, the system comprising:
a query window management system operable to display a query window for receiving a query text input by a user from at least one of a text shown in the query window, a text shown in the preview window, a text shown in a document, a text document moved by the user into the query window through a drag-and-drop operation, or a text document uploaded by the user from a local or remote file system;
a search result presentation system operable to display a search result window for displaying a result list of relevant documents returned by a search;
a preview window management system operable to display a preview window for displaying at least part of the content of a relevant document listed in the search result window; and
an activation tool operable to start a search at a search engine based on the query text,
wherein the query window management system is adapted to receive a text of any length in the query window and to forward the text received in the query window to the search engine.

2. The system of claim 1, further comprising a query history database for storing historical data of executed queries, and a query history management system in communication with the query history database and operable to display a query history window for presenting historical data of executed queries.

3. The system of claim 2, wherein the query history management system is configured to:
receive search result data from the query history database upon termination of a search run,
analyze the search result data with respect to a plurality of executed search result data, and
return analysis data to the query history database.

4. The system of claim 3, wherein the query history management system is configured to display a plurality of interactive information elements in the query history window, wherein each information element is associated with a particular executed query.

5. The system of claim 4, wherein upon the selection of a first information element in the query history window by a user, the query history management system is configured to display a first query text associated with the first information element.

6. The system of claim 5, wherein upon the selection of a second interactive element in the query history window by the user, the query history management system is configured to display a difference between a second query text associated with the second information element and the first query text associated with the first information element.

7. The system of claim 4, wherein the query window management system is further configured to receive a text selected by the user from the text displayed in the query history window upon the selection of an information element in the query history window by the user.

8. A computer-implemented method of interfacing with a search engine comprising:
displaying a graphical user search interface on a screen of a user device, wherein the graphical user search interface comprises:
a query window for receiving a query text, wherein the query window is adapted to receive text of any length,
a search result window for displaying a result list of relevant documents returned by a search,
a preview window for displaying at least a portion of a relevant document listed in the search result window, and
an activation tool operable to start the search at a search engine based on the query text,
receiving in the query window, a text input by a user from at least one of a text shown in the query window, a text shown in the preview window, a text shown in a document, a text document moved by the user into the query window through a drag-and-drop operation, or a text document uploaded by the user from a local or remote file system, and
forwarding the text in the query window to the search engine.

9. The method of claim 8, further comprising displaying a query history window for presenting historical data of executed queries.

10. The method of claim 9, further comprising displaying interactive graphical information elements in the query history window, wherein each information element is associated with a particular executed query.

11. The method of claim 10, wherein upon selection of a first information element in the query history window by the user, the method further comprises the step of displaying a first query text associated with the first information element.

12. The method of claim 11, wherein upon selection of a second information element in the query history window by the user, the method further comprises the step of presenting a difference between a second query text associated with the second information element and the first query text associated with the first information element.

13. The method of claim 10, wherein upon selection of a first information element in the query history window by the user, the method further comprises the step of receiving a text selected by the user from the text displayed in the query history window.

14. A non-transitory computer-readable storage medium storing computer program instructions configured to instruct a computer processor to:
display a graphical user search interface including:
a query window for receiving a query text, wherein the query window is adapted to receive a text of any length,
a search result window for displaying a result list of relevant documents returned by a search,
a preview window for displaying at least part of a relevant document listed in the search result window, and
an activation tool operable to start the search at a search engine based on the query text;
receive, in the query window, a text input by a user from at least one of a text shown in the query window, a text shown in the preview window, a text shown in a document, a text document moved by the user into the query window through a drag-and-drop operation, or a text document uploaded by the user from a local or remote file system, and
forward the text received in the query window to the search engine.
